(19) United States
(12) Patent Application Publication
(10) Pub. No.: US 2019/0341623 A1
(43) Pub. Date: Nov. 7, 2019

(54) CARBON COATED NANO-MATERIALS AND METAL OXIDE ELECTRODES, AND METHODS OF MAKING THE SAME

(71) Applicant: National Technology & Engineering Solutions of Sandia, LLC, Albuquerque, NM (US)

(72) Inventor: Timothy N. Lambert, Albuquerque, NM (US)

(21) Appl. No.: 15/968,198

(22) Filed: May 1, 2018

(51) Int. Cl. H01M 4/88; H01M 4/86; H01M 4/96; H01M 4/90

(52) U.S. Cl. CPC H01M 4/8825; H01M 4/9016; H01M 4/96; H01M 4/8657

(57) ABSTRACT

A transition metal oxide nanomaterial has a catalytically active surface containing a plurality of metal ion catalysts. A coating is formed of pyrolyzed carbon positioned on the transition metal oxide nanomaterial catalytically active surface. The pyrolyzed carbon coating is formed by pyrolyzing a carbon precursor, such as by pyrolyzing a saccharide. The coating covers the nanomaterial at least partially. The transition metal oxide nanomaterial forms a coated nanomaterial and the coated nanomaterial contains less than 10% carbon.

### STATEMENT REGARDING FEDERALLY SPONSORED RESEARCH OR DEVELOPMENT

The United States Government has rights in this invention pursuant to Contract No. DE-AC04-94AL85000 between the United States Department of Energy and Sandia Corporation, and pursuant to Contract No. DE-NA0003525 between the United State Department of Energy and National Technology and Engineering Solutions of Sandia, LLC, for the operation of the Sandia National Laboratories.

### BACKGROUND OF THE INVENTION

The application generally relates to carbon coated nanostructures. The application relates more specifically to carbon coated nanostructures with improved conductivity and stability that are particularly suitable for highly efficient fuel cells, photovoltaic and other alternate energy sources.

Fuel cells and metal-air batteries are promising electrochemical technologies for supporting increased grid penetration of intermittent renewable power, e.g., solar and wind. Fuel cells are electrochemical cells that convert chemical energy from a fuel reactant into electricity. Examples of fuel reactants include hydrogen, alkanols, alkanes, and other hydrocarbons. Fuel cells are different from conventional batteries in that fuel cells are open systems.

Metal-air batteries are electrochemical cells that use anodes made from pure metal and external cathodes of ambient air. In some cases, an aqueous electrolyte is utilized. Some metal-air batteries are considered to be an attractive technology with the potential of grid-scale energy storage.

Fuel cells and metal-air batteries that utilize ambient or pure oxygen as a fuel for the cathodic discharge reaction have certain kinetic limitations. These kinetic limitations include the kinetic limitations of an oxygen reduction reaction that must be addressed to increase device capacity and deliver electricity at a competitive levelized cost. Thus, electrocatalysts are needed to catalyze the oxygen reduction reaction at low overpotential with preference to the four electron pathway, and must meet elemental abundance and durability constraints.

Currently, the use of carbon/platinum compounds is contemplated, but these compounds typically comprise 5-40% platinum, which is expensive. Such compounds are expensive and inefficient, such that the ability to commercialize such compounds and/or devices is limited. What is needed is a system and/or method that overcome these limits. Other features and advantages will be made apparent from the present specification. The teachings disclosed extend to those embodiments that fall within the scope of the claims, regardless of whether they accomplish one or more of the aforementioned needs.

### SUMMARY OF THE INVENTION

One embodiment relates to an apparatus that includes a transition metal oxide nanomaterial having a catalytically active surface containing a plurality of metal ion catalysts, and a coating formed of a pyrolyzed carbon precursor, such as but not limited to pyrolyzed saccharides, therein positioned on the transition metal oxide nanowire catalytically active surface, wherein the coating covers the nanomaterial at least partially, and wherein the transition metal oxide nanomaterial forms a coated nanomaterial and the coated nanomaterial contains less than 10% carbon. The pyrolyzed carbon is formed from pyrolyzing a carbon precursor to form the pyrolyzed carbon. In an embodiment, the carbon precursor may be a saccharide and the pyrolyzed carbon may be a pyrolyzed saccharide. Pyrolyzed carbon formed herein is formed at low temperatures, less than or equal to 800° C., and is an amorphous, porous solid that is not graphitic.

Another embodiment relates to a method for coating nanomaterials. A quantity of a carbon precursor, such as, but not limited to saccharides is dissolved in a polar solvent solution to form a precursor solution. A plurality of transition metal oxide nanomaterials is mixed into the precursor solution to form a dispersion. The dispersion is heated to a temperature of at least about 800 degrees C. for at least about one hour to coat the transition metal oxide nanomaterials, at least partially.

Alternative exemplary embodiments relate to other features and combinations of features as may be generally recited in the claims.

### BRIEF DESCRIPTION OF THE DRAWINGS

The application will become more fully understood from the following detailed description, taken in conjunction with the accompanying figures, wherein like reference numerals refer to like elements, in which:

FIG. 1 is a block diagram of an embodiment of a coated nanomaterial in accordance with the subject matter of the disclosure.

FIG. 2 is a schematic diagram illustrating an exemplary process for forming a coated nanomaterial in accordance with the subject matter of the disclosure.

FIG. 3 is an exemplary method in accordance with the subject matter of the disclosure.

FIG. 4 is a powder X-ray diffraction (PXRD) of the material of Example 2.

FIG. 5 illustrates X-ray photoelectron spectroscopy (XPS) spectra of the material of Example 2.

FIG. 6 is an SEM image of the material of Example 2.

FIG. 7 is a graph of measured single-nanowire resistance and calculated conductivity measurements for carbon coated nanowires, as compared to reported values for certain uncoated transition metal oxide nanomaterials.

FIG. 8 is a graph of RRDE-derived oxygen reduction reaction transfer number (n) values.

FIG. 9 is a graph of chronoamperometric oxygen reduction reaction activity for carbon coated nanowires as compared to a reference material.

### DETAILED DESCRIPTION OF THE INVENTION

Before turning to the figures which illustrate the exemplary embodiments in detail, it should be understood that the application is not limited to the details or methodology set forth in the following description or illustrated in the figures. It should also be understood that the phraseology and terminology employed herein is for the purpose of description only and should not be regarded as limiting. Unless otherwise indicated percentages are expressed by weight.

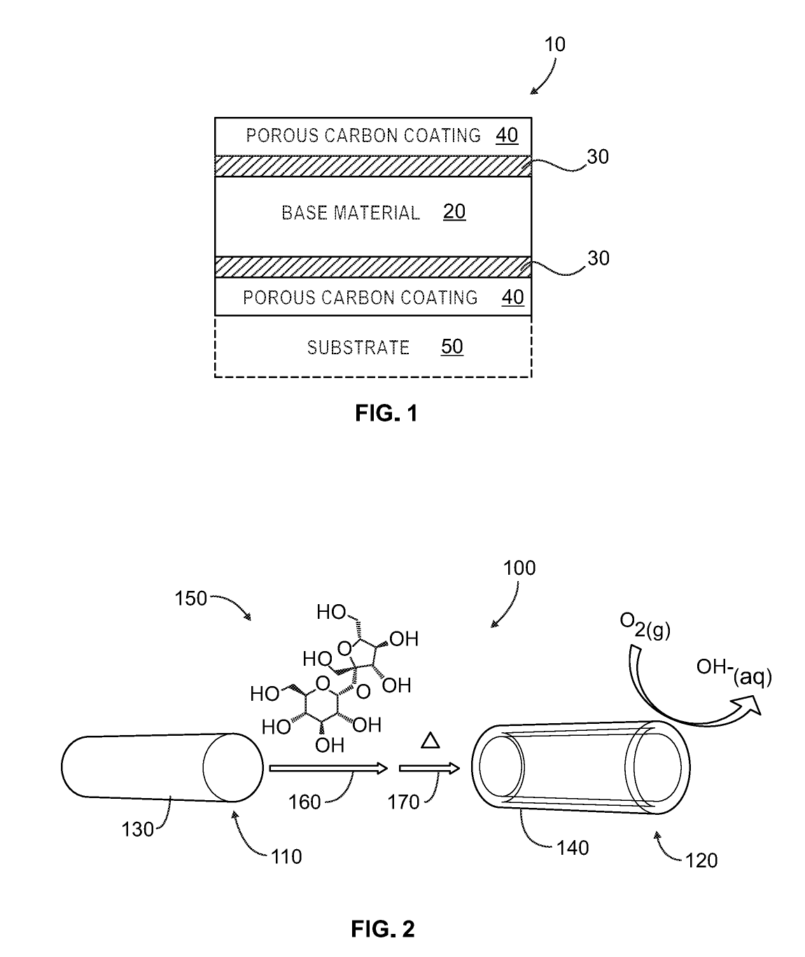

Referring to FIG. 1, a coated nanomaterial, generally designated by the numeral 10, is shown upon a substrate 50 (see [0050], for example). The coated nanomaterial 10 is particularly suitable for highly efficient fuel cells, photovoltaic and other alternate energy sources. The coated nanomaterial 10 includes base material 20 that has a catalytically active surface 30 on opposite sides. A porous carbon coating 40 abuts the catalytically active surface 30 on each side of the base material 20.

The base material 20 is formed from transition metal oxides. Transition metal oxides are a class of active and abundant electrocatalyst materials in alkaline electrolyte due to unfilled d-orbitals and reversible redox transitions near the thermodynamic potential of the oxygen reduction reaction. In this exemplary embodiment, transition metal oxides provide cheap, abundant precursors that can be used in “green” synthetic methods with limited carbon content and that can provide increased electrocatalytic activity.

The porous carbon coating 40 can be a thin, porous carbon coating 40 that surrounds the base material 20, at least partially, to provide improved conductivity and stability. The coated nanomaterial 10 has a low carbon content, i.e., less than ten percent by weight of carbon. In some embodiments, the coated nanomaterial 10 contains less than two percent by weight of carbon. The base material 20 can be nanomaterials in the form of nanoparticles, nanowires, nanorods, nanosheets, and other similar nanostructures.

The carbon coating 40 can be formed by pyrolyzing a carbon precursor, such as but not limited to saccharides, at a predetermined temperature for a predetermined time to form a pyrolyzed carbon coating. In some embodiments, the carbon coating 40 is formed from pyrolyzing sucrose. In other embodiments, the carbon coating 40 is formed by pyrolyzing five member saccharides, six member saccharides, and/or other low molecular weight saccharides.

In an embodiment, the pyrolyzed carbon results from pyrolyzing the class of molecules and polymers including saccharides: including monosaccharides, disaccharides, oligosaccharides and polysaccharides. Examples include pentoses such as fructose, hexoses such as glucose or dextrose and disaccharides such as sucrose, lactose or maltose, including other higher molecular weight saccharide containing species/polymers including [cellulose, methylcellulose (Mn˜40 k), hydroxyethyl cellulose (Mv˜90 k, Mw˜250 k, Mv˜720 k, Mv˜1,300 k), hydroxypropyl cellulose (Mw˜80 k, Mw 100 k, Mw˜370 k , Mw˜1,000 k), hydroxyethyl methyl cellulose, hydroxypropyl methyl cellulose (˜86 k, or 15,000-20,500 cP at 2 wt %), ethyl hydroxyethyl cellulose, carboxymethyl cellulose (Mw˜90 k, Mw˜250 k, Mw˜700 k), hemicellulose, (starch, amylum, amylose, amylopectin), chitosan, glycol chitosan, methyl glycol chitosan (and/or blends thereof).

In an embodiment, the carbon precursor is from the class of mono-furans or monopyrans, difurans or dipyrans, oligofurans or oligopyrans and poly(furans) and/or poly(pyrans). In another embodiment, the pyrolyzed carbon results from the use of O, S, N and Se containing molecules such as mono-, di-, oligo- and poly-species comprised of: phenols, thiophenols, aniline, benzeneselenol, thiophene, pyrrole, pyridine. In yet another embodiment, the pyrolyzed carbon comes from the use of a heterocycle or fused heterocycles comprised of five or six membered rings, fused rings and polymers or combinations thereof

The carbon coating 40 can provide improved stability and cycle-ability properties. The carbon-coating 40 can be effective in stabilizing and increasing the activity of metal and metal phosphide electrocatalysts.

The base material 20 can include manganese oxide compounds and barium manganese oxide compounds, such as, but not limited to BaMnO₃ and CaMnO₃. Manganese is extremely abundant and available in a wide range of valence states and tunable oxide crystal structures. The electroactivity of manganese oxides (MnOₓ) in the presence of oxygen can originate from a Mn³⁺/Mn⁴⁺ redox couple in octahedral sites. The resulting structural activity can result in increased oxygen reduction reaction activity with a Mn valence in compounds that include MnO, MnO₂, MnOOH, Mn₂O₃, Mn₅O₈ and Mn₃O₄ with active surfaces.

The base material 20 can include Mn oxides, Mn perovskites, MnO₂, MnOOH, Mn₂O₃, Mn₅O₈ and Mn₃O₄. The base material 20 can be prepared hydrothermally to form nanowires. Hydrothermal preparation can produce the catalytically active surface 30, which can contain a plurality of metal ion catalysts thereon. In some embodiments, the metal ion catalysts can be Mn³⁺ ions.

The coated nanomaterial 10 can be deposited on a substrate 50 to facilitate the formation of a nanoscale device. In some embodiments, the substrate 50 can be a prefabricated silica substrate. In other embodiments, the coated nanomaterial 10 can be drop cast onto the substrate 50.

The substrate 50 can be formed into a photoresist in some embodiments. In other embodiments, the coated nanomaterial 10 can be deposited onto a gas diffusion electrode, which can be accomplished by spraying or painting onto the substrate. In other embodiments, the coated nanomaterial 10 can be mixed with a polymeric binder and rolled out to form an electrode.

Referring to FIG. 2 with continuing reference to the foregoing figure, a schematic diagram illustrating a process, generally designated by the numeral 100, for coating a transitional metal oxide nanomaterial 110 to form a coated nanomaterial 120 is shown. In this exemplary embodiment, the nanomaterial 110 includes a manganese oxide-based material that has a catalytically active surface 130. The catalytically active surface 130 may be a surface that contains redox active couples to catalyze a reaction. The catalytically active surface 130 may be a surface that contains redox couples that are further activated upon performing the electrocatalytic reaction. The catalytically active surface 130 may change upon the heating to form the porous carbon coating and become more active.

The coated nanomaterial 120 can be carbon-coated α-MnO₂ nanowires that are prepared from α-MnO₂ nanowires by a two-step sucrose coating and pyrolysis method. The transitional metal oxide nanomaterial 110 can be an α-MnO₂ base material that has increased surface Mn³⁺.

A carbon coating 140 is formed on the coated nanomaterial 120 by dissolving a quantity of a carbon precursor 150, such as but not limited to saccharides in a polar solvent solution to form a precursor solution at Step 160. The precursor solution is mixed with the manganese oxide base materials to form a dispersion. In some embodiments, the polar solvent solution is an alcohol solution.

The dispersion is heated to a temperature of at least about 800 degrees C. for at least about one hour to form the coated nanomaterials 120 at Step 170. In some embodiments, the dispersion is dried and heated afterward. In other embodiments, the dispersion is heated without an additional drying step.

The carbon coating process 170, which produces the carbon coating 140 on the nanomaterial 110 to provide 120, suppresses a phase change to Mn₃O₄ at high temperatures. The enhanced physical and electronic properties of the coated nanomaterial 120 are manifested in the electrocatalytic activity toward the oxygen reduction reaction, namely a thirteen-fold increase in specific activity and a six-fold decrease in charge transfer resistance.

The carbon coating 140 is an amorphous carbon coating that has a thickness of less than 5 nanometers. The coated nanomaterial 120 has less than 2% carbon and a conductivity of at least about 0.52 S cm⁻¹.

The carbon coating process 170 to form the carbon coating 140 promotes phase retention from the α-MnO₂ nanomaterial 110 despite the pyrolysis step at 800° C. The carbon coating 140 can serve as a semi-protective layer that suppresses the phase transformation from α-MnO₂ to Mn₃O₄ on the time scale of the reaction. The coated nanomaterial 120 can include Hausmannite Mn₃O₄.

The coated nanomaterial 120 can have an oxygen reduction reaction onset potential that is within 20 mV of commercial 20% Pt/C and chronoamperometric current/stability equal to or greater than 20% Pt/C at high overpotential, e.g., 0.4 V vs RHE and high temperature, e.g., 60° C.

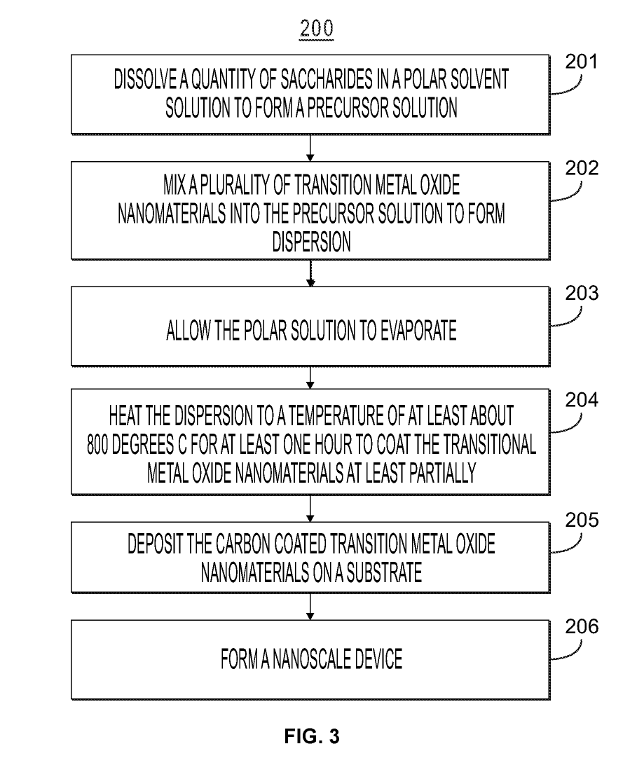

Referring to FIG. 3 with continuing reference to the foregoing figures, a method 200 is illustrated as an embodiment of an exemplary process for producing a coated nanomaterial in accordance with features of the described subject matter. Method 200, or portions thereof, can be performed to produce nanomaterials that have the structures and properties of the various embodiments of coated nanomaterials discussed above. For example, method 200 can be performed to produce the coated nanomaterial 10 shown in FIG. 1 or the coated nanomaterial 120 shown in FIG. 2.

At 201, a quantity of a carbon precursor, such as but not limited to saccharides, is dissolved in a polar solvent solution to form a precursor solution. In this exemplary embodiment, the carbon precursor is a saccharide, such as but not limited to sucrose, five member saccharides, six member saccharides, and/or other low molecular weight saccharides. The polar solvent solution can be a solution comprising about 80% ethyl alcohol and about 20% deionized water. In case of insoluble sugar containing polymers, a mildly caustic solution can be utilized to aide dissolution and/or dispersion.

At 202, a plurality of transition metal oxide nanomaterials is mixed into the precursor solution to form a dispersion. In this exemplary embodiment, the transition metal oxide nanomaterials can be manganese oxide compounds and barium manganese oxide compounds, such as BaMnO₃. The manganese oxide compounds can be Mn oxides, Mn perovskites, MnO₂, MnOOH, Mn₅O₈, Mn₂O₃, and Mn₃O₄.

At 203, the polar solvent solution is allowed to evaporate. In some embodiments, the dispersion is dried before being subject to heating. In other embodiments, the dispersion is heated without the evaporation step, so that the solvent is driven off in a furnace.

At 204, the dispersion is heated to a temperature of at least about 800 degrees C. for at least about one hour to form carbon coated transition metal oxide nanomaterials 205. In this exemplary embodiment, the coated nanomaterials can be coated nanowires, nanorods, nanosheets, and other similar nanostructures. The coated nanomaterials have a low carbon content, i.e., less than 2%. The porous carbon coating is less than 5 nm.

At 206, a nanoscale device is formed. In this exemplary embodiment, the device can be formed by depositing the carbon coated transition metal oxides on a prefabricated silica substrate to be formed into a photoresist. In other embodiments, the carbon coated transition metal oxide nanomaterials are deposited onto a surface to test oxygen reduction reaction activity.

In other embodiments, the carbon coated transition metal oxide nanomaterials are deposited on an electrode surface to form an electrocatalytic electrode. The nanomaterials can be mixed with binder material and, in some embodiments, can be mixed with more carbon and rolled into an electrode. The nanomaterials can be used to form batteries or fuel cells. The nanomaterials can be aerosol sprayed or painted onto a gas-diffusion electrode for fuel cells or metal-air battery applications.

### EXAMPLES

### Example 1

In Example 1, α-MnO₂ nanowires were prepared hydrothermally. KMnO₄ (2.78 g, 0.0176 mol. Sigma Aldrich) was added to 95 mL of deionized water. The solution was stirred for approximately 10 minutes. MnSO₄:H₂O (1.11 g, 0.0066 mol. Alpha Aesar) was added to the above solution and allowed to stir until the salts were fully dissolved to form a dark solution. The dark solution was transferred to a 125 mL capacity Teflon-lined stainless steel autoclave, and placed in an oven at 140° C. The temperature was maintained for 120 hours. Then, the autoclaves were removed and allowed to cool to room temperature to form α-MnO₂ nanowires. The α-MnO₂ nanowires were collected by centrifugation. Then, the α-MnO₂ nanowires were washed four times with deionized water and four times with ethyl alcohol (200 proof, Pharmco-Aaper). After isolation by rotary evaporation, the product was dried overnight in a vacuum oven at 60° C.

### Example 2

In Example 2, carbon coated nanowires were prepared using the α-MnO₂ nanowires of Example 1. Ultra-pure sucrose was dissolved in a 4:1 volume to volume ratio of 200 proof ethyl alcohol and deionized water to form a precursor solution. The α-MnO₂ nanowires of Example 1 were added to the precursor solution to form a homogeneous brown dispersion, e.g., 95% α-MnO₂: 5% sucrose, by weight. The dispersion was heated to about 80° C. under vigorous stirring to slowly drive off the solvent to form a solid product. The solid product was transferred to a vacuum oven and heated to 60° C. overnight. The solid product was collected and transferred to an alumina crucible and heated in a tube furnace under nitrogen-flow, e.g., 100 mL min⁻¹ to 800° C., e.g., about 3.2° C. min.⁻¹ for 1 hour. The product carbon coated nanowires were collected after cooling naturally under nitrogen-flow.

The surface area for the carbon coated nanowires was lower than the precursor α-MnO₂ nanowires. The average pore diameter decreased from 13.4 nm for the α-MnO₂ nanowires to 10.3 nm for the carbon coated nanowires. The volume decreased from 0.31 cm³ g⁻¹ for the α-MnO₂ nanowires to 0.03 cm³ g⁻¹ for the carbon coated nanowires. The sucrose retained about 21% and the α-MnO₂ nanowires retained about 87.67% during the pyrolysis step ramp to 800° C. The carbon content of the carbon coated nanowires was determined to be less than 2%. The thickness of the porous carbon coating was determined to be less than 5 nm.

The coating process produced carbon coated nanowires that had an increase in surface Mn³⁺ and in average oxidation state, e.g., AOS. The AOS for the uncoated α-MnO₀₂ nanowires was determined to be 3.88. The AOS for the carbon coated nanowires was determined to be 3.66.

### Examples 3-5

In Examples 3-5, the materials of Example 2 were characterized using Power X-Ray Diffraction (PXRD), Raman Scattering Spectroscopy, and X-Ray Photoelectron Spectroscopy (XPS)

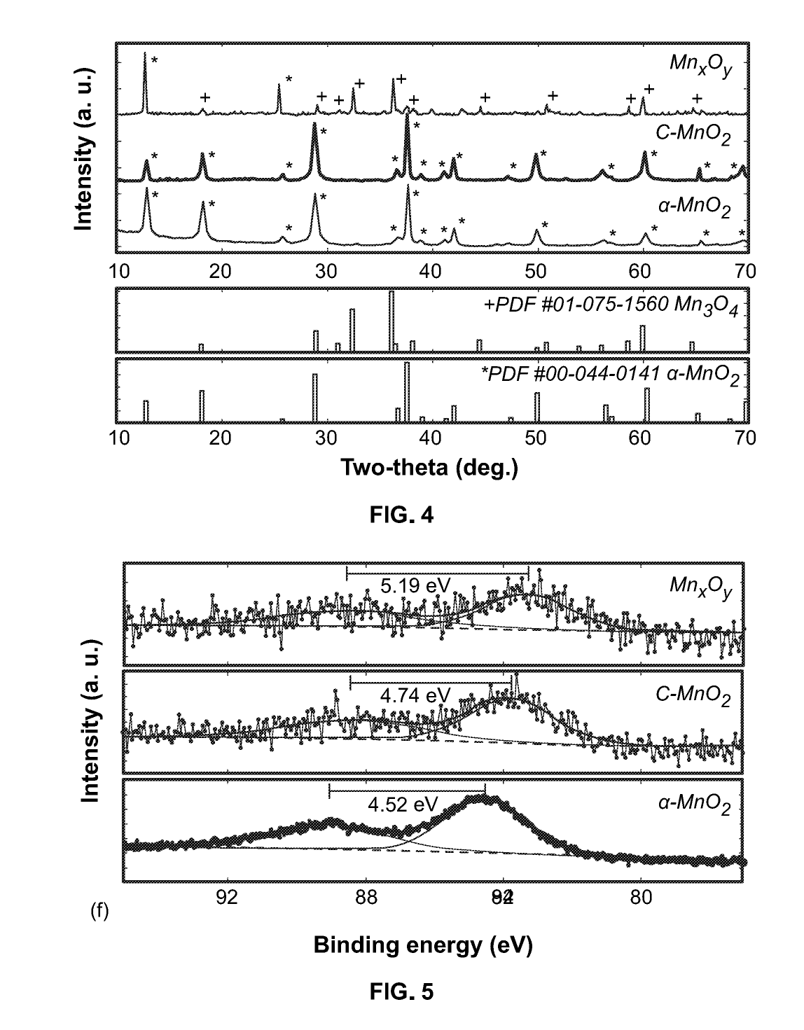

In Example 3, the α-MnO₂ nanowires powders were dispersed in ethyl alcohol and drop-cast on zero-background Si PXRD plates. Patterns were collected using a PANalytical X'Pert PRO powder diffractometer connected to the X'Pert Data Collector software suite. Ten-minute scans were run from 10-80 degrees 20 with no rotation and a source power of 45 kV and 40 mA. The patterns were analyzed using MDI Jade 9 software with the ICPDD database. The PXRD spectrum is shown in FIG. 4.

In Example 4, Raman measurements were performed utilizing a WiTec alpha300R Raman microscope with 2.5 mW of 532 nm laser light using a 55×/0.5 NA objective. All measurements were performed with a 600 l/mm grating resulting in a spectral resolution of about 1 cm⁻¹. Line scans were taken over a 50 mm distance with a spectrum acquired every 2 μm. Spectral response showed no significant spatial dependence allowing for use of the average response in which the raw output was smoothed using a Savitzky-Golay filter.

In Example 5, XPS measurements were performed with samples loaded on to carbon tape prior to analysis. Spectra were collected using a Kratos AXIS Ultra DLD photoelectron spectrometer with a monochromatic Al Kα, e.g., 1486.7 eV source. The analysis area was an elliptical spot size of 300×700 microns. Several locations on each sample were analyzed to obtain a representative sampling. Survey spectra were recorded at pressures less than 5×10⁻⁹ Torr with 80 eV pass energy, 500 meV step sizes, and 100 ms dwell times. High resolution spectra were collected with a 20 eV pass energy, 50 meV step sizes, and 100 ms dwell times. Data processing was performed with CasaXPS Version 2.3.15. High-resolution core-level peaks were compared by normalizing counts for each respective core-level.

Mn₃O₄ and α-MnO₂ indexes are shown in FIG. 4. The α-MnO₂ nanowire pattern is indexed to the Cryptomelane (α) phase of MnO₂. The carbon coated nanowires deviate in a non-uniform manner to lower angles with increasing two-theta, which is indicative of an expansion of the unit cell. The absence of a (002) reflection from graphitic carbon in the C-MnO₂ pattern at ca. 26° is consistent with an amorphous state of the carbon coating.

Raman bands characteristic of graphitic carbon were not observed, in line with amorphization of the carbon and a net increase in sp³ carbon that occurs with this process. The PXRD pattern for the MnₓO_{y} nanowires is indexed to Hausmannite Mn₃O₄ and a preferred orientation of (110) planes of α-MnO₂ that remain. The pattern indicates that the bulk percentage of Mn₃O₄ and α-MnO₂ phases are about 70% and about 30%, respectively.

High-resolution XPS spectra and peak fits in the Mn 3 s binding energy region are shown in FIG. 5. The surface Mn³⁺ content of the carbon coated nanowires is higher than α-MnO₂ nanowires. The surface Mn³⁺ content of the carbon coated nanowires is also higher than what can be achieved through copper and nickel doping.

### Example 6

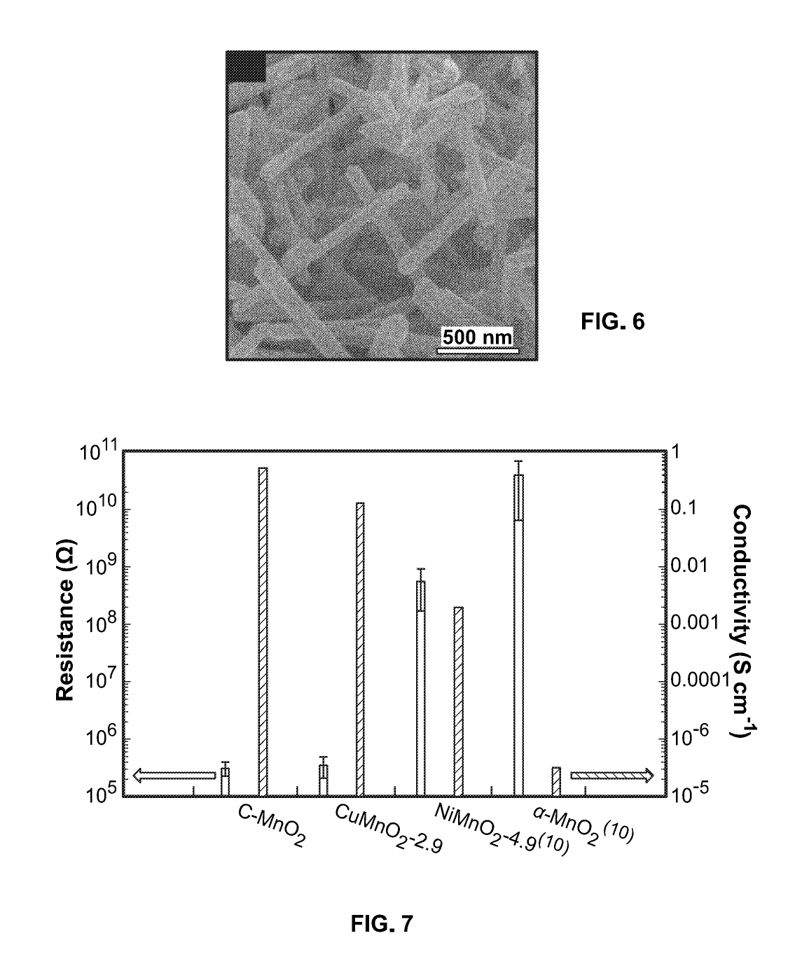

In Example 6, the materials of Example 2 were characterized using scanning/high resolution transmission electron microscopy (STEM/HRTEM). The materials of Example 2 were analyzed using a FEI Company Titan G2 80-200 operated at 200 kV, equipped with a spherical aberration corrector on the probe-forming optics and four silicon-drift X-ray detectors. TEM, selected-area diffraction (SAD), STEM, and X-ray microanalysis data were also acquired with an FEI Company Tecnai F30-ST operated at 300 kV. The X-ray spectral image data were analyzed with Automated eXpert Spectral Image (AXSIA) multivariate statistical analysis software to both filter noise and extract the relevant chemical components with no a priori input as to what elements may be present. SAD patterns were analyzed to extract interplanar spacing values for comparison to data for the relevant chemical phases. An SEM image of the carbon coated nanowires is shown in FIG. 6.

### Examples 7-8

In Examples 7-8, the materials of Example 2 were characterized using iodometric titrations and elemental analysis.

In Example 7, about 10-15 mg of α-MnO₂ or carbon coated nanowires were dissolved in 10 mL of 6 M HCl. Then, about 0.3 g of KI was added followed by 1 mL of starch indicator solution, e.g., 1% in water. The solution was then immediately titrated with about 0.1 M Na₂S₂O₃ that was previously standardized against a 0.01667 ( 1/60) M KIO₃ standardized solution. The solution was titrated to a faint yellow color.

In Example 8, about 5 mg of α-MnO₂ or carbon coated nanowires were dissolved in 3 mL of concentrated 60% HNO₃. The solution was then diluted to a mass of 100 g by deionized water. The resulting solution was diluted once more by adding 1 g of solution to 9 g of 2% HNO₃ to make a final concentration of 5 ppm MnO₂ or carbon coated MnO₂. A Perkin Elmer Nexlon 350D ICP-MS instrument was then used to analyze this solution to obtain the manganese atomic content of the materials.

The carbon coated nanowires showed an increase in concentration of Mn3+ as compared to the uncoated α-MnO₂ resulting in a decrease in manganese AOS for the carbon coated nanowires.

### Example 9

Single-nanowire, four-point contact devices were fabricated and tested to compare the resistance and conductivity of the carbon coated nanowires to the semiconducting α-MnO₂ nanowires. About 2.5 mg of α-MnO₂ or carbon coated nanowires were added to 3 mL of isopropanol (99%, Pharmco-Aaper), then sonicated to separate the material into discrete nanowires. About 50 μL of each suspension was drop-cast onto Si/SiO₂ prefabricated substrates.

The α-MnO₂ and carbon coated nanowires were aligned in accordance with layout prepared by a semiconductor layout design drawing program. A ninety second ozone plasma treatment was then used to promote adhesion to two-layer photoresists having an improved lift-off profile. The first layer, EL9, i.e., 9% copolymer, methyl methacrylate acid (MMA), and methacrylic acid (MAA) in ethyl lactate, was applied by spin-coating at 4000 rpm for thirty seconds resulting in a layer having about 300 nm thickness. After a ninety second bake at 180° C., the second layer, PMMA 950 K-A2, (i.e., 2% polymethyl methacrylate in anisole, was applied by spin-coating at 4000 rpm for thirty seconds resulting in a about 50 nm thickness. This was followed by another bake at 180° C. for ninety seconds.

Electron beam lithography (EBL) was performed using an FEI NovaNanoSEM instrument with Nanometer Pattern Generation System software. The contact pattern features were written with an area dose of 325 μC/cm². The grid alignment marks on the substrate were used to ensure the accurate placement of the electrode contacts and contact pads. The pattern was then developed for seventy-five seconds using a 1:3 methyl isobutyl ketone (MIBK) to isopropanol developer followed by a fifteen seconds rinse in isopropanol. Next, 5 nm of titanium followed by 150 nm of gold was evaporated onto the EBL patterned substrate. Lift-off of the remaining photoresist was the performed by soaking the platform in acetone overnight leaving behind only the written contacts and nanowires.

A four-terminal measurement was then performed using an Agilent Technologies B1500 semiconductor device analyzer. The voltage was swept between 0 and 20 V on the outer contacts to apply a current while the voltage was monitored between the inner contacts. The slope of the corresponding I-V curve was then used to report the resistance values. Using these resistance values and the length and diameter of the nanowires obtained by SEM, the conductivity of the wires could be calculated.

The potential between the outer contacts was swept from 0 to 20 V for activation and the current-voltage behavior of the inner contacts was measured. The voltage drop between the inner contacts was used to calculate the resistance of the nanowires according to Ohm's law. The resistance of the carbon coated nanowires was determined to be five orders of magnitude less than the α-MnO₂ nanowires, as shown in FIG. 7. Similarly, the conductivity of the carbon coated nanowires was determined to be five orders of magnitude more conductive than the α-MnO2 nanowires. The comparison indicates that carbon coating is a more effective approach to increasing nanowire conductivity than cation doping.

### Examples 10-11

In Examples 10-11, α-MnO₂, carbon coated nanowires, MnₓO_{y}, C_{sucrose} and commercial 20% Pt/C catalyst films were drop-cast onto rotating disk electrode (RDE) and rotating ring disk electrode (RRDE) working electrodes from 2.5 mg mL⁻¹ inks. In a typical ink, 2.5 mg catalyst powder, 0.75 mL deionized water, 0.2 mL i-PrOH and 0.05 mL 5% Nafion solution were combined and sonicated for less than 20 min prior to drop-casting. 10 μL of ink was cast on 0.2475 cm² glassy carbon RRDE electrodes (Pine Research Instrumentation) and 5 μL of ink was cast on 0.0707 cm² glassy carbon RDE electrodes (Bioanalytical Systems, Inc.), resulting in a loading of 0.101 mg cm⁻² or 0.177 mg cm⁻², respectively, for all catalysts. Catalyst films were tested in 0.1 M KOH electrolyte that was purged and blanketed with oxygen for oxygen reduction reaction experiments, or argon for background-current experiments.

In Example 10, RDE experiments were carried out using a RDE-2 three-electrode cell with a rotating working electrode (Bioanalytical Systems, Inc.), controlled by a VersaSTAT 4 potentiostat (Princeton Applied Research) and the VersaStudio software suite. The glassy carbon/catalyst film rotating working electrode was accompanied by an Ag/AgCl (3 M NaCl) reference electrode and platinum coil counter electrode. Linear scanning voltammetry (LSV) and electrochemical impedance spectroscopy (EIS) methods were used to assess the oxygen reduction reaction activity of the catalysts. LSV scans were collected scanning from 0.1 V to −0.7 V vs Ag/AgCl at a scan rate of 5 mV s⁻¹ at rotation rates of 500, 900, 1600, 2500 and 3600 RPM. Potentiostatic EIS spectra were collected at 10 mV RMS at the half-wave potential of the obtained LSV curves for each respective catalyst, by scanning frequency from 105 to 10⁻² Hz. High-temperature oxygen reduction reaction studies were conducted in a modified jacketed cell at 60° C. with 1 M NaOH electrolyte under constant oxygen purging. Potentiostatic experiments were sustained at 0.72 V vs. RHE for 10 min. and 0.42 V vs RHE for 1 hour.

A comparison of the oxygen reduction reaction activity of the carbon coated nanowires to nickel doped and copper doped α-MnO₂ nanowire values demonstrated that the carbon coating provides enhanced specific activity relative to the intrinsically modified nickel and copper doped α-MnO₂ nanowires. The carbon-coating resulted in a less resistive electrocatalyst at low overpotential.

In Example 11, RRDE experiments were carried out using a MSR rotating disk stand three-electrode cell controlled by a WaveDriver 20 bipotentiostat (Pine Research Instrumentation) with the AfterMath software suite. A glassy carbon disk/Au ring working electrode was used to ensure that hydroperoxy anion oxidation was diffusion-limited on the ring electrode for oxygen reduction reaction mechanism analysis. Collection efficiency was determined for each catalyst-coated electrode using the [Fe(CN)₆]³⁻/[Fe(CN)₆]⁴⁻ redox couple on an electrode identical to that used for oxygen reduction reaction LSV studies. The cell also included a SCE (0.1 M KCl) reference electrode and platinum wire counter electrode. Independent studies utilizing a carbon counter electrode were also performed in order to alleviate any concerns of platinum contamination of the working electrode. LSV scans were collected scanning the disk from 0.2 V to −0.8 V vs SCE at a rate of 5 mV s⁻¹ while holding the holding the ring electrode at 0.3 V vs SCE. Percent peroxide generation (p) and electron transfer number (n) values were calculated using the measured disk (oxygen) reduction current, and collection efficiency-normalized ring (hydroperoxy) oxidation current.

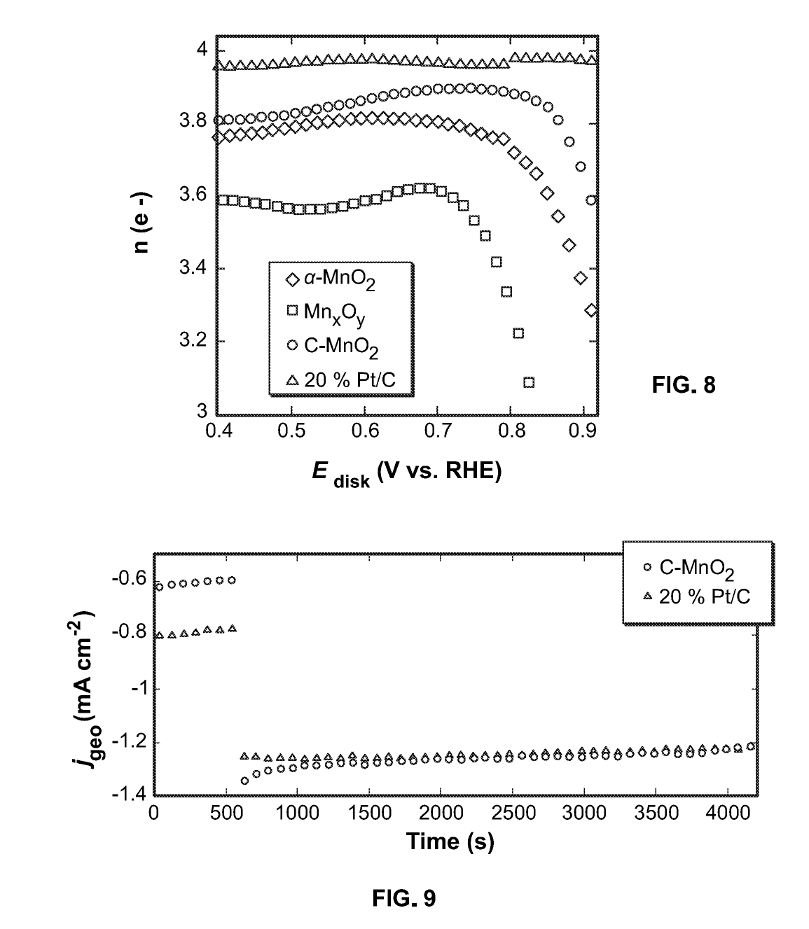

FIG. 8 shows the n value as a function of the applied electrode potential that illustrates the benefit of carbon coating, particularly in the observed reduction of peroxide formation at low overpotential and in the increase in stability. FIG. 9 illustrates that the 20% Pt/C outperforms the carbon coated nanowires in j_{geo} at low overpotential, but that both catalysts are stable and maintain geometric current density of −1.2 mA cm⁻² for one hour at high overpotential.

The electrocatalytic oxygen reduction reaction activity of the carbon coated nanowires originates from the MnO₂ surface, despite encapsulation (i.e., at least partial encapsulation) and possible oxygen reduction reaction activity from the carbon coating. The 10.3 nm average pore diameter of the carbon coated nanowires demonstrates sufficient porosity in the nanoscale carbon coating for mass transfer of solvated oxygen and oxygen reduction reaction product ions between the bulk electrolyte and the catalytically active MnO₂ surface.

The carbon coated nanowires had enriched of surface Mn³⁺ and increased single-nanowire conductivity. The increase in surface Mn³⁺ character reduces the required overpotential to drive the oxygen reduction reaction by stabilizing oxygen adsorbates and improving rates of electron transfer. The increased conductivity facilitates current distribution through the nanowire network and to the surface, which improves active site utilization.

The electrocatalytic oxygen reduction reaction activity and stability of the carbon coated nanowires compared to 20% Pt/C is notable considering non-precious metal catalysts require high mass loading and/or blending with a conductive carbon to achieve such competitive activity. The carbon coated nanowires demonstrated an oxygen reduction reaction onset potential within 20 mV of commercial 20% Pt/C and chronoamperometric current/stability equal to or greater than 20% Pt/C at high overpotential (0.4 V vs RHE) and high temperature (60° C.).

The oxygen reduction reaction potentials and overall activity of the carbon coated nanowires are competitive with highly active carbon-coated metals, sulfides, and phosphides despite lower mass loading and C content: 24.8% C for porous carbon-coated cobalt sulfide nanocomposites and at 88% C for FeP embedded in nitrogen, phosphorous (N,P)-doped porous carbon nanosheets.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the carbon coated nanostructures as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

1. An apparatus comprising:
a transition metal oxide nanomaterial having a catalytically active surface containing a plurality of metal ion catalysts, and
a coating comprising pyrolyzed carbon positioned on the transition metal oxide nanomaterial catalytically active surface,
wherein the pyrolyzed carbon covers the nanomaterial at least partially, and
wherein the transition metal oxide nanomaterial forms a coated nanomaterial and the coated nanomaterial contains less than 10% carbon.

2. The apparatus of claim 1, wherein the nanomaterial is selected from the group consisting of nanoparticles, nanowires, nanorods, and nanosheets.

3. The apparatus of claim 1, wherein the pyrolyzed carbon results from pyrolyzing a saccharide.

4. The apparatus of claim 3, wherein the saccharide is selected from a group consisting of monosaccharides, disaccharides, oligosaccharides and polysaccharides.

5. The apparatus of claim 1, wherein the pyrolyzed carbon results from pyrolyzing a compound selected from a group consisting of mono-furans or monopyrans, difurans and dipyrans, oligofurans and oligopyrans, and poly(furans) and poly(pyrans).

6. The apparatus of claim 1, wherein the pyrolyzed carbon results from pyrolyzing a compound selected from a group consisting of O, S, N and Se containing carbon molecules such as mono-, di-, oligo- and poly-species comprised of: phenols, thiophenols, aniline, benzeneselenol, thiophene, pyrrole, pyridine.

7. The apparatus of claim 1, wherein the pyrolyzed carbon results from pyrolyzing a heterocycle or fused heterocycle compound comprising five or six membered rings, fused rings and polymers or combinations thereof.

8. The apparatus of claim 1, wherein the metal ion catalysts are manganese ions.

9. The apparatus of claim 1, wherein the transition metal oxides are selected from the group comprising barium manganese oxides, Mn oxides, Mn perovskites, MnO₂, MnOOH, Mn₂O₃, Mn₅O₈ and Mn₃O₄.

10. The apparatus of claim 1, further comprising a substrate for supporting the coated nanomaterials.

11. The apparatus of claim 1, wherein the coating is an amorphous carbon coating.

12. The apparatus of claim 11, wherein the amorphous carbon coating is porous.

13. The apparatus of claim 11, wherein the amorphous carbon coating has a thickness of less than 5 nanometers.

14. The apparatus of claim 1, wherein the coated nanomaterial has a conductivity of at least about 0.52 S cm⁻¹.

15. A method for coating nanomaterials, comprising:
dissolving or dispersing a quantity of a carbon precursor in a polar solvent solution to form a precursor solution,
mixing one or more transition metal oxide nanomaterials into the precursor solution or suspension to form a dispersion, and
heating the dispersion to a temperature of at least about 800 degrees C. for at least about one hour to coat the transition metal oxide nanomaterials.

16. The method of claim 15, wherein the transition metal oxide nanomaterials is selected from a group consisting of nanoparticles, nanowires, nanorods, and/or nanosheets.

17. The method of claim 15, further comprising:
hydrothermally preparing the nanowires to form a catalytically active surface containing a plurality of metal ion catalysts thereon.

18. The method of claim 17, wherein the metal ion catalysts are manganese ions.

19. The method of claim 15, wherein the transition metal oxide nanomaterials are formed of materials selected from a group consisting of barium manganese oxides, Mn oxides, Mn perovskites, MnO₂, MnOOH, Mn₂O₃, Mn₅O₈, and Mn₃O₄.

20. The method of claim 15, further comprising:
allowing the polar solvent solution to evaporate before heating the dispersion.

21. The method of claim 15, further comprising:
forming a nanoscale device with the transition metal oxide nanomaterial.

22. The method of claim 15, wherein the polar solvent solution includes about 80% ethyl alcohol and the balance is water or an aqueous alkaline solution.

23. The method of claim 15, wherein the carbon coated transition metal oxide nanowires have less than 10% carbon.

24. The method of claim 15, wherein the carbon precursor is a saccharide.

25. The method of claim 15, wherein the carbon precursor is selected from a group consisting of mono-furans or monopyrans, difurans and dipyrans, oligofurans and oligopyrans, and poly(furans) and poly(pyrans).

26. The method of claim 15, wherein the carbon precursor is selected from a group consisting of O, S, N and Se containing carbon molecules such as mono-, di-, oligo- and poly-species comprised of: phenols, thiophenols, aniline, benzeneselenol, thiophene, pyrrole, pyridine.

27. The method of claim 15, wherein the pyrolyzed carbon results from pyrolyzing a heterocycle or fused heterocycle comprised of five or six membered rings, fused rings and polymers or combinations thereof.

28. The method of claim 15, wherein the carbon precursor is selected from a group consisting of mono-furans or monopyrans, difurans and dipyrans, oligofurans and oligopyrans, and poly(furans) and poly(pyrans).

29. The method of claim 15, wherein the carbon precursor is selected from a group consisting of O, S, N and Se containing carbon molecules such as mono-, di-, oligo- and poly-species comprised of: phenols, thiophenols, aniline, benzeneselenol, thiophene, pyrrole, pyridine.

30. The method of claim 15, wherein the pyrolyzed carbon results from pyrolyzing a heterocycle or fused heterocycle compound comprising five or six membered rings, fused rings and polymers or combinations thereof.
